(19) United States
(12) Patent Application Publication
(10) Pub. No.: US 2007/0238568 A1
(43) Pub. Date: Oct. 11, 2007

(54) Cam-based infinitely variable transmission

(76) Inventor: Derek Lahr, Blacksburg, VA (US)

Correspondence Address: James W. Hiney, Esq., P. O. Box 818, Middleburg, VA, 23060, US

(21) Appl. No.: 11/401,054

(22) Filed: Apr. 10, 2006

(51) Int. Cl. F16H 37/02

(52) U.S. Cl. 475/207

(57) ABSTRACT

A cam based infinitely variable transmission incorporation a ratcheting drive mechanism with one set of planetary gears and a cam with two followers mounted on a carrier with said gears and adapted to in infinitely variable in output but maintain a uniform output for a given uniform input. The followers are can be shifted in relation to the three dimensional cam by a shifter and clutches are used to handle the relative motion of the gears and follower shafts.

This invention relates to a cam-based infinitely variable transmission which solves the old problem of ratcheting based infinitely and constant varialble transmissions which is non uniform output for a uniform input.

### BACKGROUND

The infinitely variable transmission (IVT) has been around for a long time and continues to the present day. Constantinesco developed such a transmission for an automobile in 1920. Present automobiles have a continuously variable transmission (CVT) which are of the belt or torroidial type. Ratcheting IVTs convert a rotational input to a variable reciprocating motion and then use ratchets to rectify this motion. The transmission ratio is changed by varying the amplitude of the reciprocation motion. Ratcheting infinitely variable transmissions are in use today in many applications. For example, John Deere uses a CVT to regulate feed rates in its Air Seeder. Honda uses a similar ratcheting CVT for its downhill bicycle

### THE BACKGROUND ART

The prior art in the field of CVTs can be broken down into four separate categories which are as follows:
a. Torroidal type CVTs
b. Belt type CVTs.
C. Ratcheting drive CVTs.
d. Non-uniform output CVTs
   Group a.

Among the patents disclosing torroidial type CVTs are U.S. Pat. No. 4,885,949 to Barber, U.S. Pat. No. 5,820,510 by Mazda, US publication 2003/0,060,318 to Sumi, U.S. Pat. No. 6,045,477 to Schmidt, U.S. publication 2004/0,142,785 to Inoue and U.S. Pat. No. 6,561,941 to Nissan. Typically the transmissions disclosed in these disclosures have lower efficiencies due to their high bearing loads, auxiliary components, and complex control mechanisms. I. e., all the aforementioned patents, with the exception of Barber, include one or more planetary gear sets to increase the ratio range and torque capacity of the transmission. Additionally, they all use one or more clutching units to selectively control the torque flow between the gear sets and torroidal drives. Both of these added items increase the cost and complexity of the transmission thereby making it less competitive in the marketplace and less reliable. They use additional mechanisms to optimize the transmission for the selected gear ratios and power inputs. For example both Barber and Mazda used different mechanisms to control the axial force exerted on one or more of the torroidal discs to optimize the torque capacity as related to the inputted power.

Group b.

This group includes U.S. Pat. No. 4,665,773 to Mitsubishi which shows a belt type CVT in combination with a planetary gear set. The problem with belt transmissions is that they suffer from high power losses due to friction. The losses come about from both the bearing loads on the pulley and the slippage of the belt itself on the pulley. This belt drive shown uses many sensors to measure input and output speeds and torques which enables the designer to better moderate the amount of axial force on the belt pulleys according to the transmitted torque. This increases efficiency, belt life and torque capacity seen in other belt drives like the cam-based CVTs. Unlike both belt drives and torroidal drives, ratcheting drives like cam-based CVT do not depend on the friction between several rollers or between a belt and a pulley. Transmitting power through these means is inherently inefficient. A number of frictional clutches is used instead which can transmit power with nearly 100% efficiency. The clutches only generate drag when freewheeling which is very small.

Group c

This group includes U.S. Pat. No. 4,909,101 to Terry and presents a ratcheting drive similar to the cam-based CVT drive but which is very different. It uses a number of followers placed on the outside of a variable eccentricity device to facilitate an increase in rotational velocity between the input and the output. This transmission has its eccentricity limited to the offset of a circular cam with respect to the central axis of the transmission. This feature limits the control the designer has on the functionality of the transmission. For example, if the followers are shaped to produce a uniform output the transmission cannot produce any other waveform as an output. The torque capacity of this design is also limited due to the large forces impinging on the followers. This is due to the feature which allows for the effective length of the follower decreasing as the eccentricity increases resulting in the contact stress at the contact point increasing. If this stress gets too high the transmission can fail.

Group d

Somewhat similar to group c is the grouping exemplified by. U.S. Pat. No. 6,371,881 to Benitez. Unlike the patent to Terry in Group c this particular transmission is characterized by its non-uniform output for a uniform input. The operation is similar to Terry in that there is a device which can vary the amount of rotation of several planetary gears with respect to the carrier. This design uses a slotted plate with varying eccentricity. Clutches are then used to transmit power from the gear with the greatest rotational velocity. The mechanism shown in U.S. disclosure 2003/0,221,892 is similar in concept but differs in implementation. It uses several reciprocating four bar linkages to oscillate several one way clutches which then produce a rotational output. Like Benitez though, it also exhibits a non uniform output for a given input.

### BRIEF DESCRIPTION OF INVENTION

While all these existing CVTs and IVTs using ratcheting drives exist and have existed for some time they exhibit a non-uniform output given a uniform input. The instant invention solves this dilemma by employing a cam based IVT which has a controllable output waveform which gives it the ability to produce a uniform output. The instant invention uses a cam with a shifter and follower to interact with planet gears transfer the input into a uniform output. Instead of two sets of planetary gears as most IVTs use a cam and follower mechanism is substituted for the sun gear and planetary gears to provide a uniform output. This results in the sum of the forces on the follower being equal to zero. The torque on the carrier is smaller than the input torque and by conservation of energy the rotation of the carrier must be faster that the sun gear.

The cam-based CVT is advantageous in several ways when compared to the background transmissions. Like other ratcheting drives, it exhibits higher efficiency than either torroidal or belt drives due to the nature of its power transmissions. In addition, it does not need a complex control system for operation like these drives. It can also be designed to produce a uniform output given a uniform input like the device of Terry. But unlike any of the background transmissions with ratcheting drives, its output can be matched to nearly any periodic waveform in addition to being constant. In applications with a variable power input, such as a human pedaling a bicycle, this waveform shaping can be very advantageous, increasing the overall efficient of the system.

### OBJECTS OF THE INVENTION

Accordingly, it is an object of this invention to provide an improved infinitely variable transmission for various uses, and

It is a further object of this invention to provide an improved infinitely variable transmission with a ratcheting drive, and

It is yet another object of this invention to provide an improved ratcheting variable transmission without the need of a complex control system, and

It is still another object of this invention to provide an improved ratcheting Infinitely variable transmission that can produce a uniform output given a uniform input and which output can be matched to nearly any periodic waveform in addition to being constant, and

These and other objects of the invention will become apparent when reference is had to the accompanying drawings in which.

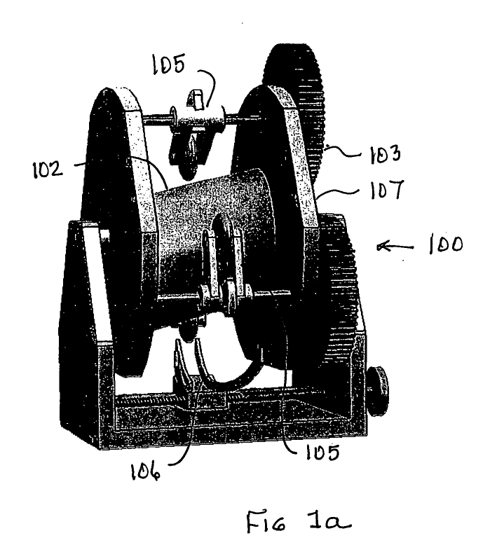

FIGS. 1a and 1b are isometric views of the transmission. FIG. 1c is a front view of the transmission shown in FIGS. 1a and 1c.

Figure two are two graphs showing follower displacement and velocity.

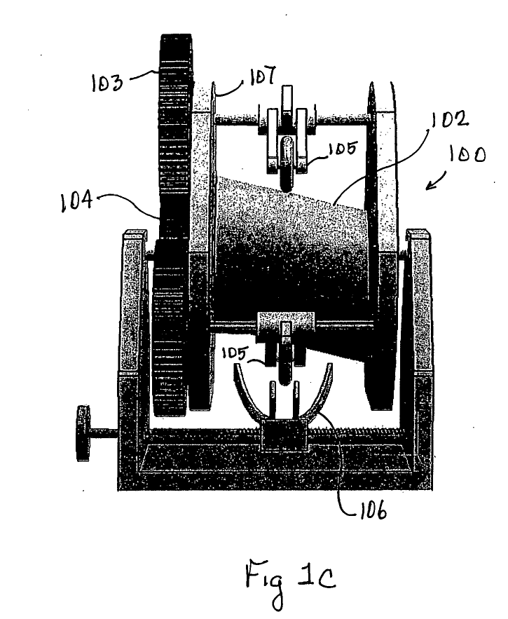

FIG. 3 is a velocity overlay showing the transfer of power between followers.

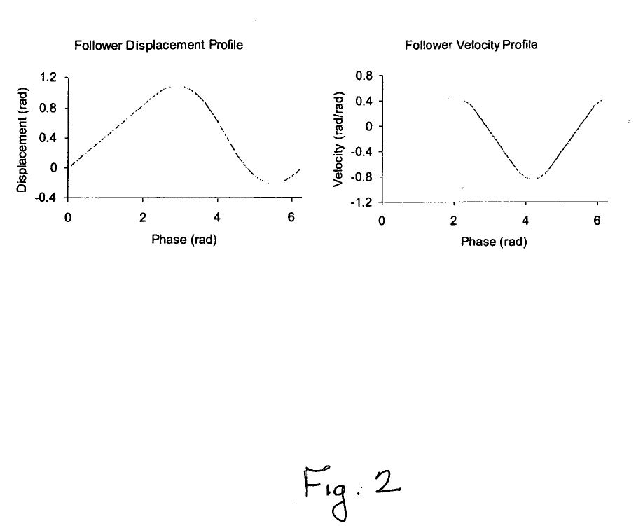

FIG. 4 is a graph showing the follower's acceleration, velocity and position as a function of cam rotation.

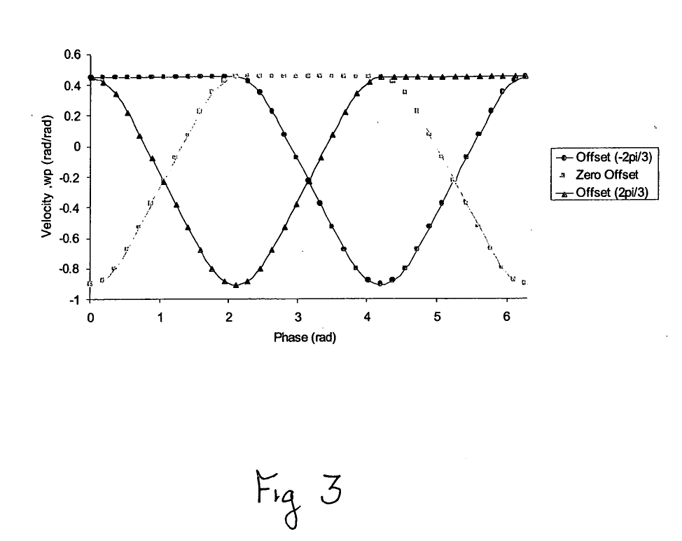

FIG. 5 shows the location of variables with respect to the transmission.

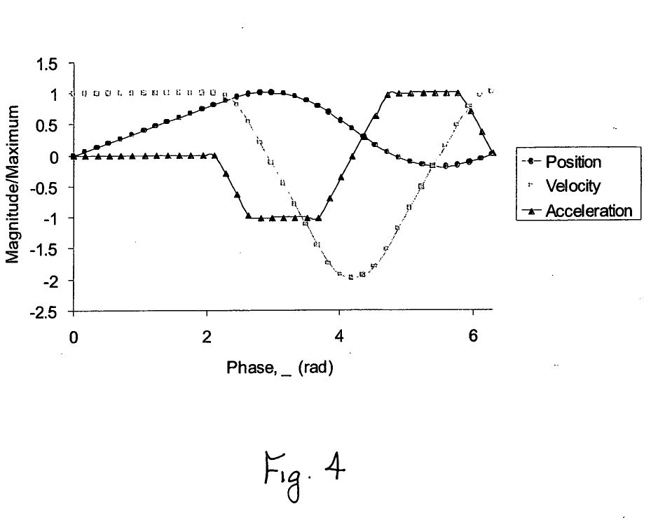

FIG. 6 shows an example of one cam profile.

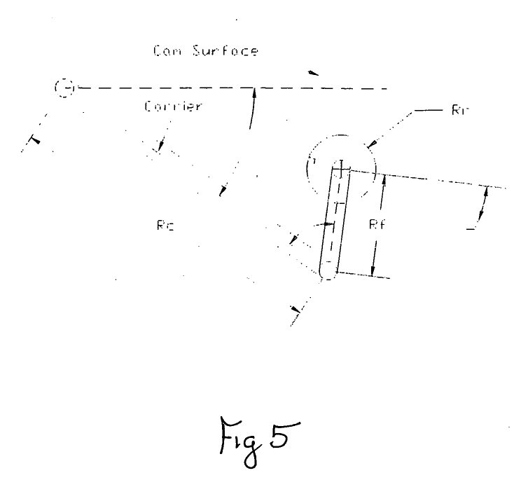

FIG. 7 shows a isometric view of one embodiment of the invention.

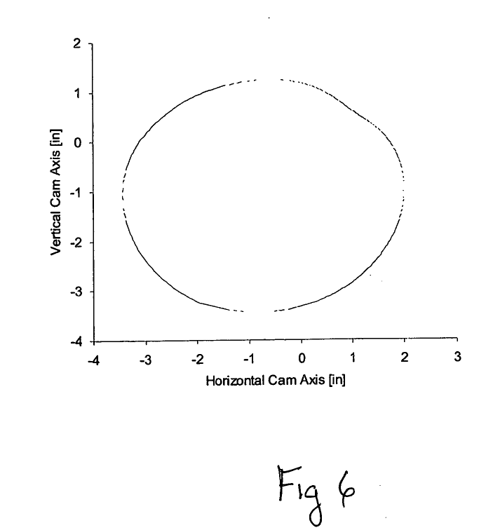

FIGS. 8 though 11 show photographs of a second embodiment of the invention

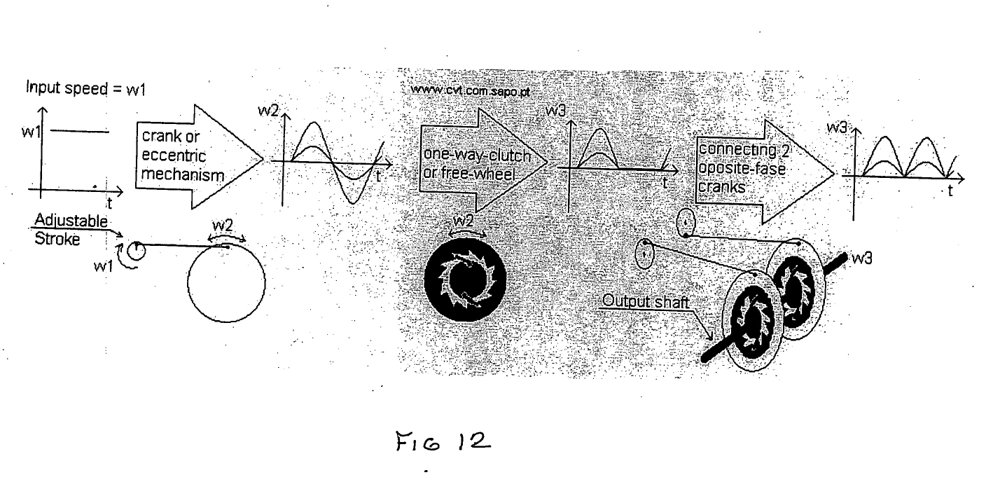

FIG. 12 shows a diagrammatic chart showing how the transmission ratio is changed.

### DETAILED DESCRIPTION OF THE INVENTION

A continuously variable transmission (CVT) is a system which allows a user to vary the speed between an input and output progressively from one positive value to another. Unlike conventional transmissions, the selection of gears is not restricted to a finite number of ratios. Infinitely variable transmissions (IVTs) are CVTs which also have a transmission ration of zero. Presented here is a novel, highly configurable, ratcheting CVT/IVT based on the operation of a planetary gearset. It is unique in both its operation and its possible applications because it combines the flexibility of a planetary gearset and a CVT into one package. Unlike other ratcheting CVTs which produce a non uniform output for a uniform input, the instant invention can shape the output to match many periodic waveforms. Consequently, this ratcheting drive has the unique ability to produce a uniform and continuous output.

The instant invention has many applications. CVTs currently improve the performance and fuel economy of many automobiles. They are also used in industrial drive applications where varying speeds are needed. Bicycles can benefit from an efficient and enclosed continuously variable transmission. This is seen in the trend towards gearbox equipped mountain bikes.

The operation of the instant transmission is based on a planatery gearset with two sun gears, a planet carrier, and a number of planet gears. In the transmission, the function of one sun gear and its planets is replaced with a centrally located cam, oscillating cam followers and indexing clutches. The three dimensional cam is an infinite series of profiles blended together and is located along the rotational axis of the planet carrier. The cam followers are keyed to the planet axles which are carried by the planet carrier. On the end of these axles are the indexing clutches which connect to the remaining planetary gears. The transmission is shown as 100 in FIGS. 1a, 1b and 1c. The clutches 101 are shown mounted on the ends of the axles. Cam 102 is shown with one set of planetary gears 103 mounted thereon with sun gear 104, which is the input gear, engaged therewith. A follower 105 rides on cam 102 and the output is carrier 107.

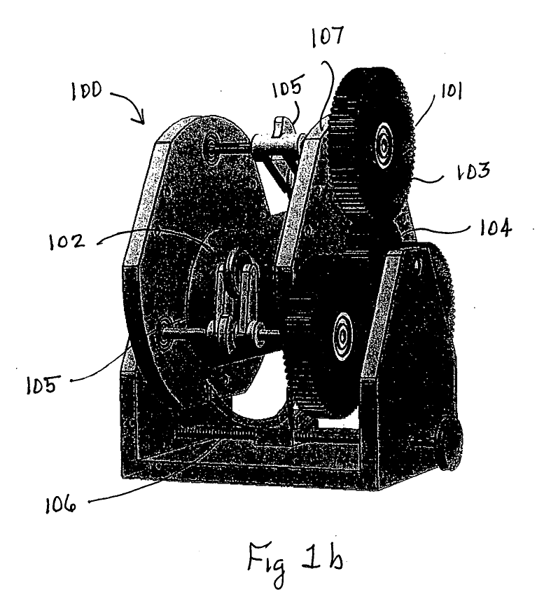

Referring to FIG. 2 there is shown charts for the follower 105 displacement profile and velocity profile. The acting planet is the planet gear with the maximum rotational velocity at any time and is the gear that is driving the output. The portion of the cam profile on which a follower, and therefore planet gear, has the maximum velocity is called the acting profile. The lift of the follower during the acting profile of the cam is given by:

$${Θ}_{1} = \frac{\pm {\int }_{0}^{2 π} max ( {w}_{p 1} ( Θ ) , {w}_{p 2} ( Θ ) , … , {w}_{pn} ( Θ ) ) ⅆ Θ}{n} , \qquad ( 1 )$$

Where cop is the velocity of the planet gear. This is illustrated in FIG. 3 which shows n velocity profiles overlaid with and offset of 2π/n. In this example n equals three for a transmission with three followers. The sign of Θ1 is positive if the follower rotates in the same direction of the cam as it rotates and is negative if they rotate in opposite directions. When the follower velocity is constant for the acting profile, Equation 1 simplifies to:

$${Θ}_{1} = \pm max ( {ω}_{p} ( Θ ) ) \frac{2 π}{n} . \qquad ( 2 )$$

A kinematic relationship can be established for any velocity profile, but this design assumes a constant velocity output. Similar to the kinematic relationships of a planetary geartrain, the motion of all of the elements must satisfy the relationships:

$${Θ}_{3} = {Θ}_{2} ( 1 - \frac{{Θ}_{1} {nr}_{p}}{2 π {r}_{3}} ) + {Θ}_{1} \frac{{Θ}_{l} {nr}_{p}}{2 π {r}_{3}} . \qquad ( 3 )$$

Differentiating Equation 3 yields:

$${ω}_{3} = {ω}_{2} ( 1 - \frac{{Θ}_{1} {nr}_{p}}{2 π {r}_{3}} ) + {ω}_{1} \frac{{Θ}_{1} {nr}_{p}}{2 π {r}_{3}} . \qquad ( 4 )$$

Equation 4 can be used for any iteration of the transmission where the corresponding velocity of the stationary component is set to zero.

A unique feature of this design is the way the indexing clutches limit the transmission ratio values for iterations in which the carrier is rotating. For these designs, Θ1 must be chosen such that the planet gear 103 rotates opposite the direction of the applied torque from the sun gear 104. This feature ensures the correct operation of the indexing clutches.

The goals of the instant inventive effort were to design a transmission with a gear ratio from one to four, a torque capability of 25 ft.lb, and a volume less than a cubic foot. Several iterations with different input and output components were scrutinized as potential designs. They were compared with the maximum input torque to the follower torque. The results of this effort is seen in Table 1. Iteration 1 was the best compromise between torque capacity and simplicity and was chosen for the design process.

TABLE 1
Input torque to follower torque relationship for various
iterations. Iteration 3 and 4 use a geared input and
corresponding transmission ratios necessary to meet the
requirements. The torque ratios for these iterations can
be varied with the input gear ratio. A nominal value is
given in parenthesis.

| Iteration | Input | Output | Tₚ/Tᵢₙₚᵤₜ |
|---|---|---|---|
| 1 | Sun | Carrier | =1.67 |
| 2 | Carrier | Sun | =6 |
| 3 | Cam | Carrier | >0 (=1.5) |
| 4 | Cam | Sun | >0 (=4) |

The cam profile was designed using a trapezoid acceleration curve. The velocity and position equations in Table 2 were found by integrating the acceleration curve. The level of acceleration needed to return the follower to its origin after the acting profile is a function of ωp and n. The equations from Table 2 were programmed into Microsoft Excel® and the acceleration was found using the “Goal Seek” function such that Θp,6 equals Θp,0.

A rotational input causes the planet carrier to rotate in relation to the cam. This causes the followers to oscillate on their axis as they move about the cam. One directional component of this oscillating motion passes through the indexing clutches and is transferred to the sun gear. Thus the rotation of the sun gear is advanced or retarded in relation to the planet carrier.

The infinite series of profiles that make up the cam allow for an infinite number of transmission ratios to be selected between two values. By varying the position of the cam followers in relation to the cam, the particular profile they follow can be changed. This affects the magnitude of the follower's oscillation and therefore the output of the transmission. Shifting is accomplished using a set of rails designed to guide the followers.

Like a planetary gearset, the input and output of this transmission can be varied between the cam, carrier or sun gear. The unique characteristics of each iteration can be matched to the particular application. For example, several iterations are contiuously variable while others are infinitely variable. In addition, this transmission can be designed as a differential device with either two inputs or two outputs.

What follows is a kinematic analysis of the cam-based IVT.

Nomenclature:
a, pressure angle of cam;
n, number of followers;
r₃, sun gear radius;
R_{c}, carrier radius;
R_{f}, follower radius;
rₚ, planet gear radius;
Rᵣ, follower roller radius;
Θ, dependent variable in the follower motion profiles;
Θ₁, angular position of the cam;
Θ₂, angular position of the carrier;
Θ₃, angular position of the sun gear;
Θₗ, magnitude of follower lift during acting profile;
Θₚ, angular position of the follower and planet gear;
T₃, applied torque to sun gear;
ω₁, angular velocity of the cam;
ω₂, angular velocity of the carrier;
ω₃, angular velocity of the sun gear;
ωₚ, angular velocity of the followers and planet gears;

The behavior of the transmission is completely dependent on the cam profile. In this section, the behavior of the transmission is described in terms of an arbitrary profile, as seen in FIG. 2. Several variables can be assigned which will help define the behavior of the transmission.

TABLE 2
Acceleration, Velocity, and Position functions.

| | | | Acceleration, | | |
|---|---|---|---|---|---|
| Phase | Θ^{′}= | n | A= | Velocity, ωₙ= | Position, ω_{p,n}= |
| [0, 2π/3) | [0, 2π/3) | 1 | 0 | ωₚ | ω_{p*}Θ^{′} = Θ_{p,0} |
| [2π/3, 5π/6) | [0, π/6) | 2 | $\frac{- α ( {Θ}^{′} )}{π / 6}$ | $\frac{- {α ( {Θ}^{′} )}^{2}}{π / 3} + {ω}_{n - 1}$ | $\frac{- {α ( {Θ}^{′} )}^{3}}{π} + {ω}_{n - 1} {Θ}^{′} + {Θ}_{p , n - 1}$ |
| [5π/6, 7π/6) | [0, π/3) | 3 | −α | αΘ^{′} + ωₙ₋₁ | $\frac{{α ( {Θ}^{′} )}^{2}}{2} + {ω}_{n - 1} {Θ}^{′} + {Θ}_{p , n - 1}$ |
| [7π/6, 3π/2) | [0, π/3) | 4 | $\frac{α ( {Θ}^{′} )}{π / 6} - α$ | $\frac{{α ( {Θ}^{′} )}^{2}}{π / 3} - {αΘ}^{′} + {ω}_{n - 1}$ | $\frac{{α ( {Θ}^{′} )}^{3}}{π} - \frac{α ( {Θ}^{′} ) 2}{π / 3} + {ω}_{n - 1} {Θ}^{′} + {Θ}_{p , n - 1}$ |
| [3π/2, 11π/6) | [0, π/3) | 5 | α | αΘ^{′}+ ωₙ₋₁ | $\frac{{α ( {Θ}^{′} )}^{2}}{2} + {ω}_{n - 1} {Θ}^{′} + {Θ}_{p , n - 1}$ |
| [11π/2, 2π) | [0, π/6) | 6 | $- \frac{α ( {Θ}^{′} )}{π / 6} + α$ | $- \frac{{α ( {Θ}^{′} )}^{2}}{π / 3} + {αΘ}^{′} + {ω}_{n - 1}$ | $\frac{- {α ( {Θ}^{′} )}^{3}}{π} + \frac{α ( {Θ}^{′} ) 2}{π / 3} + {ω}_{n - 1} {Θ}^{′} + Θ$ |

The exact position and velocity of the cam follower can be established from this level of acceleration. These can be seen for ωp=0.44[rad/rad] and n−3 in FIG. 4. FIG. 5 shows the location of all the variables used in the subsequent equations to find the cam profile.

As shown in FIG. 4, the follower's acceleration, velocity and position as a function of cam rotation. The maximum value of position, velocity and acceleration are 63.4°, 0.44 [1/sec], and 0.014[1/sec²], respectively.

With reference to FIG. 5 there is shown the location of the variable with response to the transmission. The position of the pitch curve in the reference system of the cam is given by the equations:
x=R_{c}*cos(Θ₂)−R₁ cos(Θ₂+Θₚ) (5)
y=−R_{c}*sin(Θ₂)+R_{f} cos(Θ₂+Θₚ). (6)
The position of the cam surface is then given by the equations,

$$\begin{matrix}{x}_{cam} = x + {R}_{r} ( \frac{{y}^{′}}{{w}^{′}} ) & ( 7 ) \\ {y}_{cam} = y + {R}_{r} ( \frac{{x}^{′}}{{w}^{′}} ) , \\ where & ( 8 ) \\ {x}^{′} = - {R}_{c} sin ( {Θ}_{2} ) + {R}_{f} cos ( {Θ}_{2} + {Θ}_{p} ) ( 1 + {w}_{p} ) ; & ( 9 ) \\ {y}^{′} = {R}_{c} cos ( {Θ}_{2} ) - {R}_{f} cos ( {Θ}_{2} + {Θ}_{p} ) ( 1 + {w}_{p} ) ; & ( 10 ) \\ {w}^{′} = \sqrt{{x}^{{′}^{2}} + {y}^{{′}^{2}}} [ 3 ] . & ( 11 )\end{matrix}$$

The resulting cam profile from the curves in FIG. 4 can be seen in FIG. 6 which shows an example of one cam profile. It was generated for an wp of 0.44.

The pressure angle, a, is

$$α = {cos}^{- 1} ( \frac{{x}^{′} cos ( {Θ}_{p} - {Θ}_{2} ) + {y}^{′} sin ( {Θ}_{p} - {Θ}_{2} )}{\sqrt{( {x}^{{′}^{2}} + {y}^{{′}^{2}} )}} ) . \qquad ( 12 )$$

Once a is known, the force normal to the cam is given by

$${F}_{cam} = \frac{{T}_{3} {r}_{p}}{{r}_{f} {r}_{3} cos ( α )} . \qquad ( 13 )$$

Finally, the radius of curvature is estimated for any Θ_{2,n} by the following equation,

$$\frac{ⅆ s}{ⅆ Θ} = \frac{{w}^{′} ( {Θ}_{2 , n + 1} - {Θ}_{2 , n} )}{( {tan}^{- 1} ( {y}_{n + 1}^{′} / {x}_{n + 1}^{′} ) - {tan}^{- 1} ( {y}_{n}^{′} / {x}_{n}^{′} ) )} . \qquad ( 14 )$$

The radius of the roller was chosen to be half of the minimum radius of curvature to ensure the proper motion of the follower and avoid undercutting. The contact stress was calculated because it is the limiting stress in the transmission. It was computed using the Hertzian contact stress equations for two spherical elements using the radius of curvature of the cam and the roller follower. Review showed that increasing rf, rc and n will decrease the contact stress but increase the size and weight of the transmission. In addition, increasing rf will also necessitate a smaller roller, which will eventually put an upper limit on rf.

The meet the design specification, an iterative process was used with the Excel program to optimize the design. The first iteration began with n equaling two, for which the size requirement could not be met without exceeding the elastic limit of the cam material, nylon. Increasing n to three reduced the size of the transmission and the maximum contact stress. The final values for all necessary parameters are summarized in Table 3.

TABLE 3
The final design parameters.

| Parameter | Value |
|---|---|
| n | 3 |
| R_{c} | 4 [in] |
| R_{f} | 2.25 [in] |
| Rᵣ | 0.75 [in] |
| Rₚ/Rₛ | 1.67 |
| Max (ωₚ) | 0.45 |
| Min (ωₚ) | 0 |

These parameters were incorporated into the transmission as shown in FIG. 1. The cam is molded as a splined surface through eight profiles corresponding to eight different follower velocities. The resulting transmission has a ratio range of one to four, has a maximum shear stress in the cam with a factor of safety of two and is less than a cubic foot in size.

Referring now to FIG. 7 there is shown an operational prototype constructed using Lego Technic® brand toy blocks. It was designed such that the sun is the input, the carrier is the output and the cam is stationary. This cam represents only one profile of the 3D cam which would be used in a CVT. Therefore, the model only has a transmission ratio of 3/2. The profile was constructed in NX3 using a spline though the points generated from the Excel file. It is generally designated as 200 and has cam 201, follower 202, planet gear 203, sun gear 204, input 205, ratchet 206 and carrier/output 207.

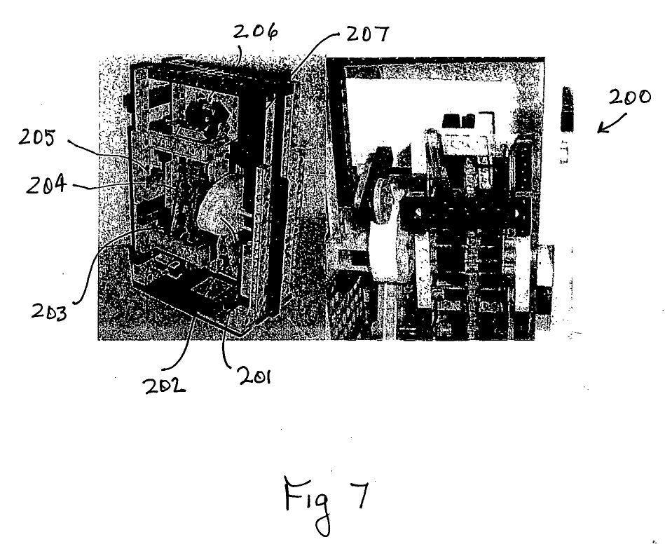

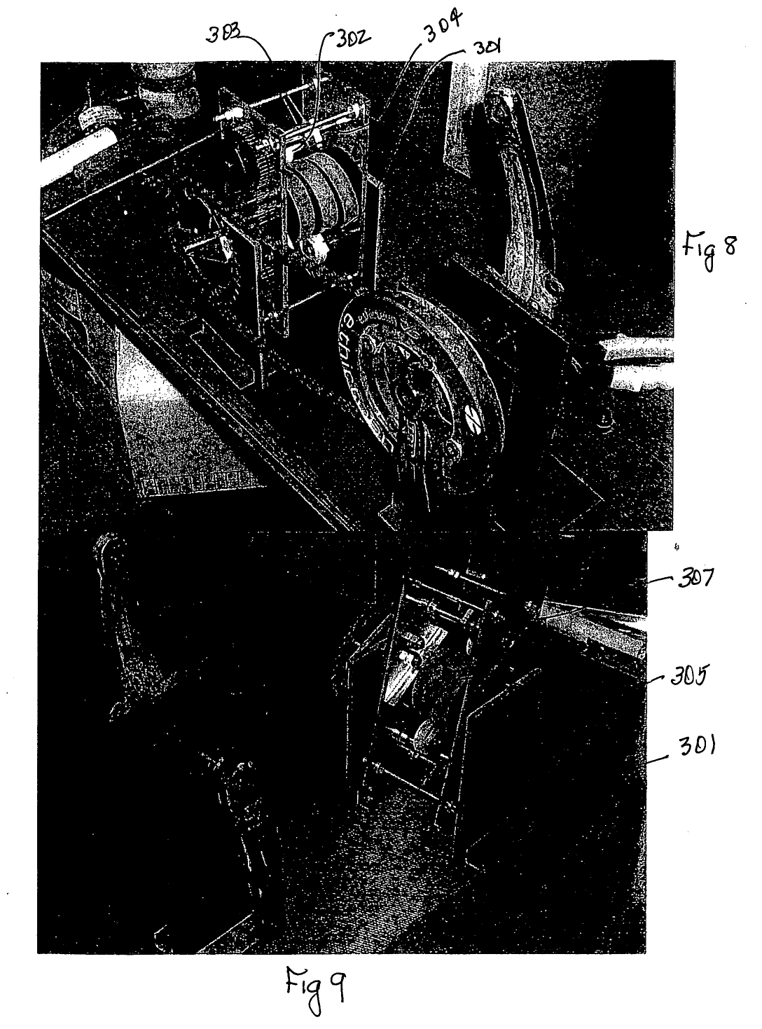

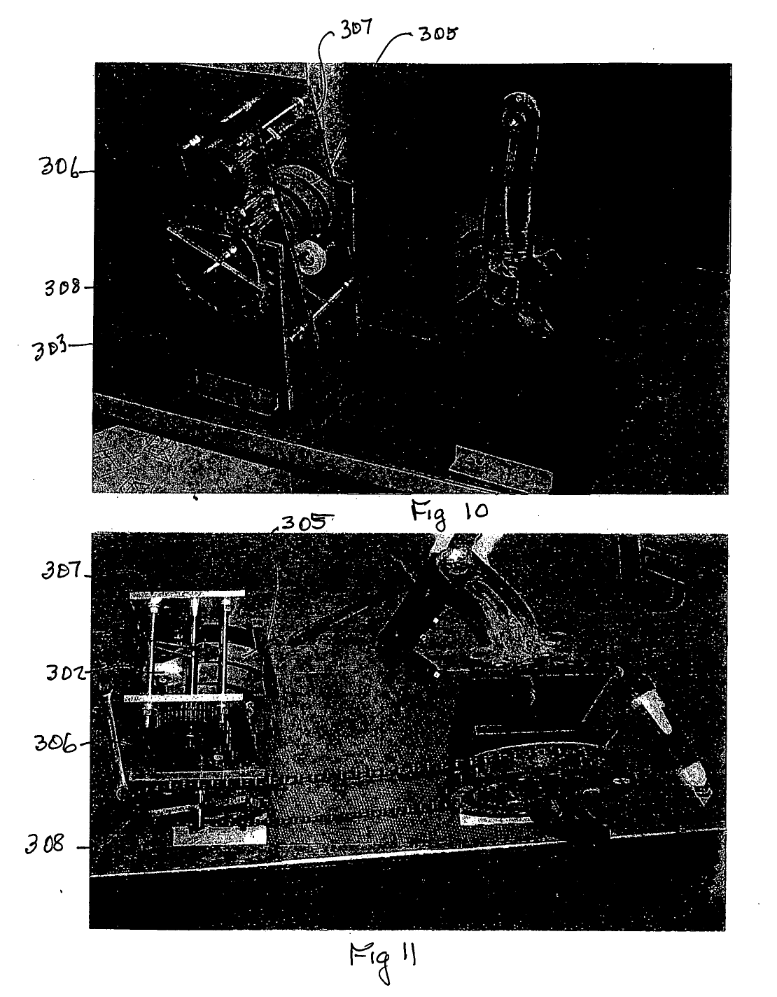

Another prototype was constructed of aluminum, steel and nylon and is shown generally as 300 in FIGS. 8 through 11. Two followers 301 and 302 were used with this model. A Sprag clutch 303 was employed between the follower and the planet gear shaft 304. The cam 305 was composed of three different cam profiles to accomplish three different ratios. Planet gears 306 were mounted on one side and the carrier/output 307 on the other. Input sprocket is shown as 308 on the drawings.

FIG. 12 is a diagrammatic drawing of how the transmission ration is changed by varying the amplitude of the reciprocation motion.

While only two embodiments of the invention have been shown and described it will be obvious to those of ordinary skill in the art that many changes and modifications can be made without departing from the scope of the appended claims.

What is claimed is:

1. An infinitely variable transmission for producing a uniform output from a uniform input, said transmission comprising.
a first mechanism having a first planetary gearset means,
a second mechanism means which acts like a second planetary gearset,
a carrier means for said first planetary gearset means, said carrier means having a rotational axis,
said first planetary gearset means providing uniform rotary input drive to said transmission and said carrier means being the output for said transmission,
whereby said mechanisms cooperate to convert said rotary input means of the transmission to uniform rotary output means along the rotational axis of said carrier means.

2. A transmission as in claim 1 wherein said first planetary gearset means includes a sun gear and at least two planetary gears.

3. A transmission as in claim 2 wherein said input drive is through said sun gear.

4. A transmission as in claim 2 wherein said second mechanism which acts like a planetary gearset includes a cam means which is adjustable to vary the output of transmission but which is able to keep it uniform.

5. A transmission as in claim 5 wherein said cam means includes a cam, at least one oscillating cam follower and indexing clutch means.

6. A transmission as in claim 5 wherein said cam means is three dimensional and made up of an infinite series of profiles blended together and is located along the rotational axis of the carrier means.

7. A transmission as in claim 5 and including a second cam follower.

8. A transmission as in claim 7 wherein said planetary gearset includes at least two planet gears and a sun gear, the cam followers each being mounted on the respective rotational axes of the two planet gears whereby rotation of the input and sun gear causes movement of said cam and cam followers to affect movement of said planet gears.

9. A transmission as in claim 8 wherein the acting planet gear with the maximum rotational velocity at any time is the gear that drives the output.

10. A transmission as in claim 8 and including indexing clutch means mounted on each output planet gear to limit the transmission ratio values for iterations in which the carrier means is rotating.

11. A transmission as in claim 10 in which the followers oscillate on their axis as they move about the cam and one directional component of this oscillation motion passes through said indexing clutch means and is transferred to the sun gear to advance or retard its rotational movement in relation to the planet gear carrier.

12. A transmission as in claim 8 wherein the position of the cam followers can be adjusted in relation to the cam to thereby change the profile of the cam they follow thereby affecting the magnitude of the follower's oscillations and the output of the transmission.

13. A transmission as claim 12 whereby the input and output of the transmission can be varied by adjusting the relationship between the cam, cam followers or the sun gear.

14. A transmission as in claim 12 and including a set of rail means which act as a shifter to change the position of the cam followers on the cam.

15. An infinitely variable transmission where the transmission ratio is zero, said transmission comprising:
a frame means to hold the components of the transmission,
a carrier means mounted for rotational movement in said frame means,
a set of planetary gear means mounted on said frame means whereby each said gear in said gear means in mounted on said carrier means for rotational movement
a cam means mounted on said frame means and operatively connected to said carrier means and said planetary means so as to convert uniform input from a portion of said planetary means to uniform rotational output of said carrier means.

17. A transmission as in claim 16 wherein said cam means includes at least two follower means, a three dimensional cam means and indexing clutch means.

18. A transmission as in claim 17 wherein said planetary means includes at least two planet gears and a sun gear, all mounted for rotational movement on said carrier, the sun gear providing an input to said transmission.

19. A transmission as in claim 17 and including a shifter means to adjust the two follower means to alternate locations to vary the output of the transmission.

20. A transmission as in claim 17 wherein said cam is three dimensional and is comprised of an infinite set of profiles blended together and is located along the rotational axis of the carrier.

21. A transmission as in claim 20 wherein said followers can oscillate as they follow the rotation of the cam and by adjusting the position thereof relative to the cam one can change the magnitude of the oscillations and the output of the transmission.

22. A transmission as in claim 16 wherein said cam means includes a cam and two cam followers which can be adjusted with relation to the cam to affect the output of the transmission.

23. A transmission as in claim 22 and including a clutch means which can affect the output of the cam followers in relationship to the output of the planetary gearset.

24. A transmission as in claim 22 including a shifter means to change the position of the cam followers in relation to the cam.
